(19) United States
(12) Patent Application Publication
(10) Pub. No.: US 2014/0045012 A1
(43) Pub. Date: Feb. 13, 2014

(54) NON-AQUEOUS ELECTROLYTE SECONDARY BATTERY

(71) Applicant: Sanyo Electric Co., Ltd., Osaka (JP)

(72) Inventors: Taiki Nonaka, Kakogawa City (JP); Keisuke Minami, Kanzaki-gun (JP); Shingo Tode, Kasai City (JP); Toyoki Fujihara, Kanzaki-gun (JP); Toshiyuki Nohma, Kobe City (JP)

(73) Assignee: Sanyo Electric Co., Ltd., Osaka (JP)

(21) Appl. No.: 13/943,093

(22) Filed: Jul. 16, 2013

(30) Foreign Application Priority Data
Aug. 9, 2012 (JP) 2012-177190

(51) Int. Cl. H01M 10/0561

(52) U.S. Cl. CPC H01M 10/0561
USPC 429/94; 429/188

(57) ABSTRACT

To provide a non-aqueous electrolyte secondary battery having high capacity and superior safety and cycle characteristics.

The present invention is a non-aqueous electrolyte secondary battery including an electrode assembly and a non-aqueous electrolyte, the electrode assembly having a positive electrode, a negative electrode and a separator separating the positive electrode and the negative electrode, the non-aqueous electrolyte secondary battery characterized in that the separator has a three-layer laminated structure, the melting point of the middle layer being lower than either of the two outer layers, and the non-aqueous electrolyte including lithium bis(oxalato)borate.

### CROSS-REFERENCE TO RELATED APPLICATIONS

This application claims the benefit of Japanese Patent Application No. 2012-177190 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the cycle characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrodes have an active material layer provided on both sides of the electrode core, and the positive electrode and negative electrode are wound together or laminated on each other via a separator to form an electrode assembly. This electrode assembly increases the opposing surface area between the positive and negative electrodes, and facilitates the extraction of a large current.

As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Documents

Patent Document 1, Published Unexamined Patent Application No. 2010-086780

The technology disclosed in Patent Document 1 is a rectangular secondary battery having a first electrode core and a second electrode core on both ends in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved output characteristics as well as improved durability, such as storage characteristics and cycle characteristics. However, these points are not considered in Patent Document 1.

In view of this situation, an object of the present invention is to provide a non-aqueous electrolyte secondary battery having superior safety and cycle characteristics.

### Means of Solving the Problem

In order to solve this problem, the present invention is a non-aqueous electrolyte secondary battery including an electrode assembly and a non-aqueous electrolyte, the electrode assembly having a positive electrode, a negative electrode and a separator separating the positive electrode and the negative electrode, the non-aqueous electrolyte secondary battery characterized in that the separator has a three-layer laminated structure, the melting point of the middle layer being lower than either of the two outer layers, and the non-aqueous electrolyte including lithium bis(oxalato)borate.

In this configuration, the non-aqueous electrolyte also contains lithium bis(oxalato)borate (LiB(C₂O₄)₂). This improves the cycle characteristics.

However, when a non-aqueous electrolyte containing lithium bis(oxalato)borate is in a high-temperature environment, its thermal stability decreases and it readily reacts with the negative electrode, raising the temperature of the battery. In the present invention, the separator interposed between the positive and negative electrodes has a three-layer laminated structure, and the melting point of the middle layer is lower than either of the two outer layers. Therefore, when the battery temperature rises abnormally, the outer layers of the separator maintain their backbone, while the middle layer melts, closes the pores of the separator, and blocks current traveling between the positive and negative electrodes. This can suppress any further increase in the battery temperature.

The separator can have a laminated structure with four or more layers, but any increase in the number of layers also increases the thickness of the separator. This reduces the volumetric energy density, and makes the manufacturing process more complicated and costly. Also, when the outer layers of the separator melt before the middle layer, the melting layer shrinks the separator and tends to create a short circuit between the positive and negative electrodes. Therefore, the separator has a three-layer laminated structure, and the melting point of the middle layer is lower than either of the two outer layers.

When the non-aqueous electrolyte contains too little lithium bis(oxalato)borate, the effect is insufficient. When too much lithium bis(oxalato)borate is added, the upper limit on effectiveness is exceeded and the additional amount is not cost effective. Therefore, the amount of lithium bis(oxalato)borate added is preferably from 0.06 to 0.18 mol/L.

The range for the amount of lithium bis(oxalato)borate in the non-aqueous electrolyte is determined based on the non-aqueous electrolyte in the non-aqueous electrolyte secondary battery after assembly and before the first charge. The range is determined in this manner because the amount gradually decreases as the non-aqueous electrolyte battery containing lithium bis(oxalato)borate is charged. This is believed to be caused by the consumption of some of the lithium bis(oxalato)borate in the formation of film on the negative electrode during charging.

The physical properties and materials in the two outer layers of the separator may be the same or different.

In this configuration, the permeability per unit of thickness of the separator can be from 7.0 to 27.0 seconds/mL·μm.

By using a separator with low permeability (allowing lithium ions to readily pass through), the output characteristics can be increased.

In this configuration, the separator can be uniaxially stretched, the positive electrode, the negative electrode and the separator in the electrode assembly can be wound, and the winding direction can be parallel to the stretching direction of the separator.

The stretching process readily produces a good, thin separator. However, some stress remains in the separator from the stretching process, which makes it more likely to shrink in the opposite direction in a high-temperature environment, directly melting the positive and negative electrodes and causing a short circuit. In a wound electrode assembly, force is applied in the winding direction to suppress stretching, and force is not applied in the direction perpendicular to this to suppress stretching. Therefore, by stretching the separator uniaxially, and arranging the stretching direction of the separator parallel to the winding direction, internal short circuiting caused by thermal stretching of the separator can be reliably suppressed when a stretched separator is used.

Because the configuration of the present invention is remarkably safe, it can be effectively used in a high-capacity battery with a capacity equal to or greater than 15 Ah, which generates a high level of heat when an internal short circuit occurs.

In the present invention, the battery capacity is the discharge capacity (initial capacity) when the battery has been charged to a battery voltage of 4.1 V using 15 A of constant current, charged for 1.5 hours at a constant voltage of 4.1 V, and then discharged after charging to a battery voltage of 2.5 V at a constant current of 15 A. The charging and discharging was performed entirely at 25° C.

### Effect of the Invention

The present invention is able to provide with high productivity a non-aqueous electrolyte secondary battery having a high capacity.

### BRIEF DESCRIPTION OF THE DRAWINGS

FIG. 1 is a perspective view of a non-aqueous electrolyte secondary battery according to the present invention.

FIG. 2 is a diagram showing the electrode assembly used in a non-aqueous electrolyte secondary battery according to the present invention.

FIGS. 3a-3b are plan views showing the positive and negative electrodes used in a non-aqueous electrolyte secondary battery according to the first embodiment of the present invention.

### DETAILED DESCRIPTION

### Embodiment 1

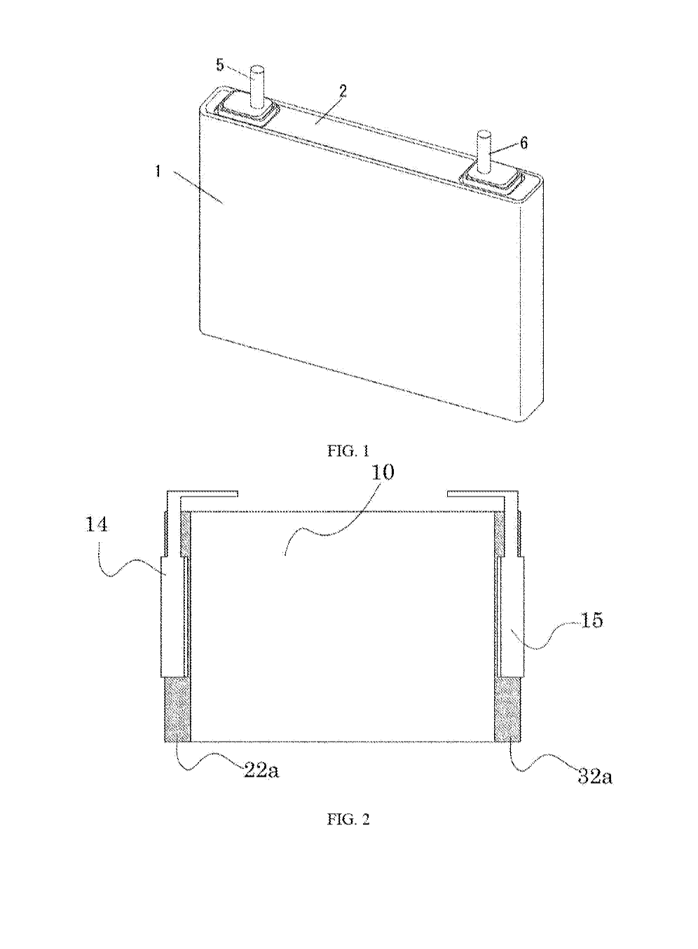

The following is an explanation with reference to the drawings of the battery of the present invention as applied to a lithium ion secondary battery. FIG. 1 is a perspective view of a non-aqueous electrolyte secondary battery according to the present invention,

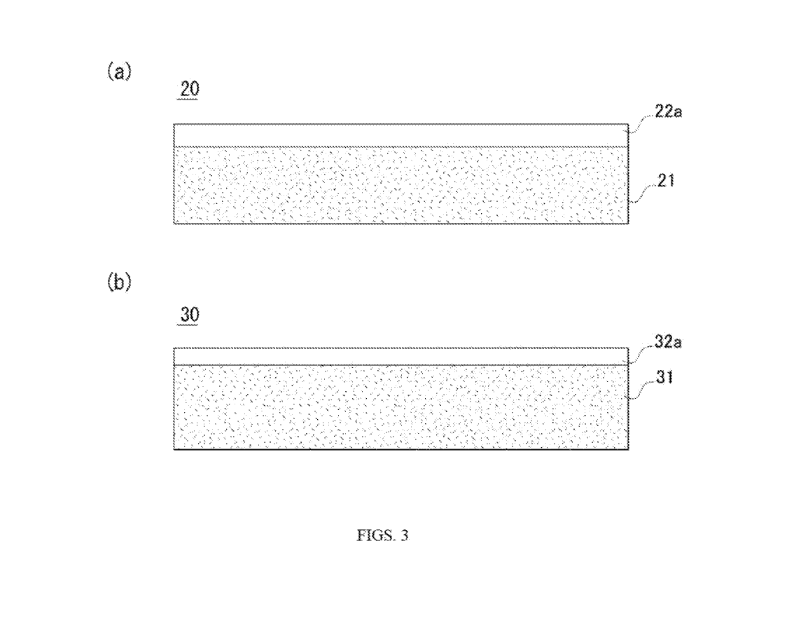

FIG. 2 is a diagram showing the electrode assembly used in a non-aqueous electrolyte secondary battery according to the present invention, and FIG. 3 is a plan view showing the positive and negative electrodes used in a non-aqueous electrolyte secondary battery according to the first embodiment of the present invention.

As shown in FIG. 1, a lithium ion secondary battery of the present invention has a rectangular outer can 1 with an opening, a sealing plate 2 for sealing the opening in the outer can 1, and positive and negative electrode terminals 5, 6 protruding outward from the sealing plate 2.

Also, as shown in FIG. 3, the positive electrode 20 in the electrode assembly has a positive electrode core exposing portion 22a exposed on at least one end in the longitudinal direction of the band-shaped positive electrode core, and a positive electrode active material layer 21 formed on the positive electrode core. The negative electrode 30 has a first negative core exposing portion 32a exposed on at least one end in the longitudinal direction of the band-shaped negative electrode core, and a negative electrode active material layer 31 formed on the negative electrode core.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector 14 is mounted on the positive electrode core exposing portion 22a, and the negative electrode collector 15 is mounted on the negative electrode core exposing portion 32a.

This electrode assembly 10 is housed inside the outer can 1 along with the non-aqueous electrolyte, and the positive electrode collector 14 and the negative electrode collector 15 are connected electrically to external terminals 5, 6 protruding from the sealing plate 2 while being insulated from the sealing plate 2 to extract current.

The non-aqueous electrolyte includes a non-aqueous solvent and an electrolyte salt dissolved in this solvent. The non-aqueous electrolyte includes lithium bis(oxalato)borate as an electrolyte salt. This improves the cycle characteristics.

The separator has a three-layer laminated structure, and the melting point of the middle layer is lower than either of the two outer layers. When a non-aqueous electrolyte containing lithium bis(oxalato)borate is in a high-temperature environment, its thermal stability decreases and it readily reacts with the negative electrode, raising the temperature of the battery. In the present invention, the separator interposed between the positive and negative electrodes has a three-layer laminated structure, and the melting point of the middle layer is lower than either of the two outer layers. Therefore, when the battery temperature rises abnormally, the outer layers of the separator maintain their backbone, while the middle layer melts, closes the pores of the separator, and blocks current traveling between the positive and negative electrodes. This can suppress any further increase in the battery temperature.

Because a non-aqueous electrolyte containing a lithium bis(oxalato)borate readily causes problems in high-capacity batteries having a discharge capacity equal to or greater than 15 Ah, the present invention can be applied to such a battery to great effect.

The following is a more detailed explanation of the present invention using examples. The present invention is not limited to these examples. The materials used, the mixing ratios, etc. can be changed when appropriate.

### Example 1

### Preparation of the Positive Electrode

The positive electrode active material slurry is prepared by mixing together a lithium-containing nickel-cobalt-manganese composite oxide (LiNi_{0.35}Co_{0.35}Mn_{0.3}O₂) serving as the positive electrode active material, a carbon-based charging agent such as acetylene black or graphite, and a binder such as polyvinylidene fluoride (PVDF) at a mass ratio of 88:9:3, and then dissolving and mixing the mixture in N-methyl-2-pyrrolidone serving as the organic solvent.

The positive electrode active material slurry is applied to a uniform thickness on both sides of band-shaped aluminum foil serving as the positive electrode core (thickness: 20 μm) using a die coater or doctoring blade. However, the slurry is not applied on the ends in the longitudinal direction of the positive electrode core (the end in the same direction on both sides) to expose the core and form the positive electrode core exposing portion.

The electrode is passed through a dryer to remove the organic solvent and create a dry electrode. The dry electrode is then rolled using a roll press. Afterwards, it is cut to a predetermined size to complete the positive electrode 20.

### Preparation of Negative Electrode

The negative electrode active material slurry is prepared by mixing together graphite serving as the negative electrode active material, styrene butadiene rubber serving as the binder, and carboxymethyl cellulose serving as the thickener at a mass ratio of 98:1:1, and then adding the appropriate amount of water.

The negative electrode active material slurry is applied to a uniform thickness on both sides of band-shaped copper foil serving as the negative electrode core (thickness: 12 μm) using a die coater or doctoring blade. However, the slurry is not applied on the ends in the longitudinal direction of the negative electrode core to expose the core and form the negative electrode core exposing portion.

The electrode is passed through a dryer to remove the water and create a dry electrode. The dry electrode is then rolled using a roll press. Afterwards, it is cut to a predetermined size to complete the negative electrode 30.

### Physical Properties of the Separator

A uniaxially stretched separator with a three-layer laminated structure was used in which the thickness was 30 μm, the permeability as measured in accordance with JISP8117:1998 was 350 sec/100 cc (or a permeability per unit of thickness of 11.7 sec/100 cc·μm), and a layer of polypropylene was applied to both sides of a polyethylene middle layer.

### Preparation of Electrode Assembly

As shown in FIG. 3, the positive electrode, the negative electrode and a polyethylene microporous membrane separator were laid on top of each other so that the positive electrode core exposing portion and the negative electrode core exposing portion protruded from the three layers in opposite directions relative to the winding direction, and so that the separator was interposed between the different active material layers. The layers were then wound together using a winding machine, insulated tape was applied to prevent unwinding, and the resulting electrode assembly was flattened using a press. At this time, the stretching direction and winding direction of the separator are parallel.

### Connection of the Collectors to the Sealing Plate

An aluminum positive electrode collector 14 and a copper negative electrode collector 15 with two protrusions (not shown) on the same surface were prepared, and two aluminum positive electrode collector receiving components (not shown) and two copper negative electrode collector receiving components (not shown) with one protrusion on one surface were also prepared. Insulating tape was applied to enclose the protrusions of the positive electrode collector 14, negative electrode collector 15, positive electrode collector receiving components and negative electrode collector receiving components.

A gasket (not shown) was arranged on the inside surface of a through-hole (not shown) provided in the sealing plate 2, and on the outside surface of the battery surrounding the through-hole, and an insulating component (not shown) was arranged on the inside surface of the battery surrounding the through-hole provided in the sealing plate 2. The positive electrode collector 14 was positioned on top of the insulating component on the inside surface of the sealing plate 2 so that the through-hole in the sealing plate 2 was aligned with the through-hole (not shown) in the collector. Afterwards, the inserted portion of a negative electrode terminal 5 having a flange portion (not shown) and an inserted portion (not shown) was inserted from outside the battery into the through-hole in the sealing plate 2 and the through-hole of the collector. The diameter of the lower end of the inserted portion (inside the battery) is then widened, and the positive electrode collector 14 and the positive electrode terminal 5 were caulked to the sealing plate 2.

The negative electrode collector 15 and the negative electrode terminal 6 were caulked to the sealing plate 2 in the same way on the negative electrode side. In this operation, the various components were integrated, and the positive and negative electrode collectors 14, 15 and the positive and negative electrode terminals 5, 6 were connected conductively. In this structure, the positive and negative electrode terminals 5, 6 protruded from the sealing plate 2 while remaining insulated from the sealing plate 2.

### Mounting of the Collectors

The positive electrode collector 14 was arranged on the side of the flat electrode assembly with the core exposing portion of the positive electrode 20 so that the protrusion was on the side with the positive electrode core exposing portion. One of the positive electrode collector receiving components is brought into contact with the positive electrode core exposing portion so that the protrusion on the positive electrode collector receiving component is on the positive electrode core exposing portion side, and so that one of the protrusions on the positive electrode collector 14 is facing the protrusion on the positive electrode collector receiving component. Next, a pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded to the positive electrode core exposing portion.

Afterwards, the other positive electrode collector receiving portion is brought into contact with the positive electrode core exposing portion so that the protrusion on the positive electrode collector receiving portion is on the positive electrode core exposing portion side, and so that the other protrusion on the positive electrode collector 14 is facing the protrusion on the positive electrode collector receiving component. Next, the pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded a second time to the positive electrode core exposing portion.

In the case of the negative electrode 30, the negative electrode collector 15 and the negative electrode collector receiving components are resistance-welded in the same way.

### Preparation of Non-Aqueous Electrolyte

Ethylene carbonate (EC) and ethyl methyl carbonate (EMC) are mixed together at a volume ratio of 3:7 (converted to 1 atm (101,325 Pa) at 25° C.), and a LiPF₆ electrolyte salt is dissolved in the resulting non-aqueous solvent at a ratio of 1.0 M (mol/L) to complete the base electrolyte solution. To the resulting base electrolyte solution are added 0.3 mass % vinylene carbonate, and 0.1 mol/L lithium bis(oxalato)borate (LiBOB). This completes the non-aqueous electrolyte.

### Assembly of Battery

The electrode assembly 10 integrated with the sealing plate 2 was inserted into the outer can 1, the sealing plate 2 was fitted into the opening in the outer can 1, the welded portion of the outer can 1 was laser-welded around the sealing plate 2, a predetermined amount of non-aqueous electrolyte was poured in via a non-aqueous electrolyte hole (not shown) in the sealing plate 2, and the non-aqueous electrolyte hole was sealed. This completes the non-aqueous electrolyte secondary battery in the first example.

### Comparative Example 1

The non-aqueous electrolyte secondary battery in the first comparative example was completed in the same manner as the first example except that a separator with the following physical properties was used.

### Physical Properties of the Separator

A biaxially stretched separator with a (single-layer) of polypropylene was used in which the thickness was 30 μm, and the permeability as measured in accordance with JISP8117:1998 was 350 sec/100 cc (or a permeability per unit of thickness of 11.7 sec/100 cc·μm). This was wound so that the winding direction was parallel to the stretching direction.

### Comparative Example 2

The non-aqueous electrolyte secondary battery in the second comparative example was completed in the same manner as the first example except that a separator with the following physical properties was used, and lithium bis(oxalato)borate was not added.

### Physical Properties of the Separator

A biaxially stretched separator with a three-layer laminated structure was used in which the thickness was 30 μm, the permeability as measured in accordance with JISP8117:1998 was 350 sec/100 cc (or a permeability per unit of thickness of 11.7 sec/100 cc·μm), and a layer of polypropylene was applied to both sides of a polyethylene middle layer.

### Comparative Example 3

The non-aqueous electrolyte secondary battery in the third comparative example was completed in the same manner as the first example except that a separator with the following physical properties was used.

### Physical Properties of the Separator

A uniaxially stretched separator with a (single-layer) of polypropylene was used in which the thickness was 30 μm, and the permeability as measured in accordance with JISP8117:1998 was 350 sec/100 cc (or a permeability per unit of thickness of 11.7 sec/100 cc·μm).

### Comparative Example 4

The non-aqueous electrolyte secondary battery in the fourth comparative example was completed in the same manner as the first example except that lithium bis(oxalato)borate was not added.

### Durability Test

The non-aqueous electrolyte secondary batteries in the first example and the first through fourth comparative examples were adjusted to a state of charge (SOC) of 50%, and maintained for more than three hours at 70° C. A cycle test was then performed. In this test, pulse cycles were performed in which the battery was discharged for three seconds at a discharge current of 80 A followed by a ten-second pause, and then discharged again for three seconds at a discharge current of 80 A followed by another ten-second pause. After 49 of these pulse cycles, 1000 cycles were performed as a single cycle until the SOC was adjusted to 50%.

After 1000 cycles, the ratio (A/B) of the initial pre-cycle output (A) to the output after 1000 cycles (B) was calculated. In the evaluation, a battery with an A/B ratio equal to or greater than 85% was considered to have good durability (O), and a battery with an A/B ratio less than 85% was considered to have poor durability (X). The results are shown in Table 1.

### Shutdown Test

The non-aqueous electrolyte secondary batteries in the first example and the first through fourth comparative examples were heated with the temperature rising at a rate of 2° C. per minute, and the internal resistance was measured at 1 kHz using a Hioki M-Ohm HiTester 3560. The temperature when the resistance value exceeds 1Ω is the shutdown temperature (T1), and the temperature when the resistance value falls below 1Ω again is the meltdown temperature (T2). When the meltdown temperature (T2) minus the shutdown temperature (T1) is equal to or greater than 20° C., the shutdown properties of the battery are good (O). When the difference is less than 20° C., the shutdown properties of the battery are poor (X). The results are shown in Table 1.

### Shrinkage Test

The separators used in the non-aqueous electrolyte secondary batteries in the first example and the first through fourth comparative examples were cut to a size of 100 mm×100 mm, both ends were fixed in the machine direction MD (the direction parallel to the winding direction), and a heat test was performed for two hours at 105° C. The ratio of the length (X mm) in the TD direction (the direction perpendicular to the winding direction) in the middle portion of the separator in the MD direction after the heat test relative to the length (100 mm) in the TD direction before the heat test was measured. When the ratio (X/100) exceeded 0.98, shrinkage of the separator was considered negligible. When the ratio was equal to or less than 0.98, shrinkage of the separator was considered to have occurred.

TABLE 1

| | | | Dura- | Shut | TD |
|---|---|---|---|---|---|
| | Separator | LiBOB | bility | Down | Shrinkage |
| Example 1 | Uniaxial Stretching, | Yes | ◯ | ◯ | No |
| | 3-Layers | | | | |
| Comp. Ex. 1 | Biaxial Stretching, | Yes | ◯ | X | Yes |
| | 1-Layer | | | | |
| Comp. Ex. 2 | Biaxial Stretching, | No | X | ◯ | Yes |
| | 3-Layers | | | | |
| Comp. Ex. 3 | Uniaxial Stretching, | Yes | ◯ | X | No |
| | 1-Layer | | | | |
| Comp. Ex. 4 | Uniaxial Stretching, | No | X | ◯ | No |
| | 3-Layers | | | | |

It is clear from Table 1 that the first example and the first and third comparative examples, which contained lithium bis(oxalato)borate (LiBOB), had good results in the durability test. In contrast, the second and fourth comparative examples, which did not contain lithium bis(oxalato)borate, had poor results in the durability test. Therefore, lithium bis(oxalato)borate is believed to have an effect which improves results in the durability test.

Also, it is clear from Table 1 that the first example and the second and fourth comparative examples, which used a three-layer laminated separator in which the middle layer has a lower melting point than the outer layers, had good results in the shutdown test. In contrast, the first and third comparative examples, which used a single-layer separator, had poor results in the shutdown test. Therefore, a single-layer separator of polypropylene is considered less likely to melt.

Also, it is clear from Table 1 that the first example and the third and fourth comparative examples, which used a uniaxially stretched separator, did not shrink in the TD direction. In contrast, the first and second comparative examples, which used a biaxially stretched separator, did shrink in the TD direction. Therefore, biaxially stretched separators, which are stretched in both the winding direction and the direction perpendicular to this (in the TD direction), are believed to shrink thermally in the TD direction because the stress from the stretching process does not act as a force which suppresses stretching. In contrast, the first example and the third and fourth comparative examples, which use a uniaxially stretched separator and which are arranged so that the winding direction is parallel to the stretching direction of the separator, are able to suppress thermal shrinkage of the separator and reliably suppress internal short circuiting.

### Additional Details

The positive electrode active material can be one or more of the following: a lithium-containing nickel-cobalt-manganese composite oxide (LiNiₓCo_{y}Mn_{z}O₂, x+y+z=1, 0<x<1, 0<y<1, 0<z<1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

The negative electrode active material can be a carbon material such as natural graphite, carbon black, coke, glassy carbon, carbon fibers, or baked products of these. These carbon materials can be used alone or in mixtures of two or more.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydrofuran or diethyl ether; or a carboxylic acid ester, such as ethyl acetate, propyl acetate or ethyl propionate. A mixed solvent including two or more types of high dielectric constant solvent and low viscosity solvent can also be used.

In addition to lithium bis(oxalato)borate (LIB(C₂O₄)₂), one or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀C₁₀, Li₂B₁₂Cl₁₂, LiB(C₂O₄)F₂, LiP(C₂O4)₃, LiP(C₂O₄)₂F₂, and LiP(C₂O₄)F₄. Lithium monofluorophosphate (LiPO₃F) and lithium difluorophosphate (LiPO₂F₂) can be added to the lithium bis(oxalato)borate and the base electrolyte salts. The total concentration of electrolyte salts in the non-aqueous electrolyte is preferably from 0.5 to 2.0 M (mol/L).

Any well-known additive, such as vinylene carbonate, cyclohexyl benzene, and tert-amyl benzene can be added to the non-aqueous electrolyte.

A microporous membrane or membrane laminate of an olefin resin, such as polyethylene arranged in the middle layer and polypropylene arranged in the surface layer, can be used as the separator.

### INDUSTRIAL APPLICABILITY

As explained above, the present invention can provide with high productivity a non-aqueous electrolyte secondary battery having a high capacity. Thus, industrial applicability is great.

### KEY TO THE DRAWINGS

1: Outer Can
2: Sealing Plate
5, 6: Electrode Terminals
10: Electrode Assembly
14: Positive Electrode Collector
15: Negative Electrode Collector
20: Positive Electrode
21: Positive Electrode Active Material Layer
22a: Positive Electrode Core Exposing Portion
30: Negative Electrode
31: Negative Electrode Active Material Layer
32a: Negative Electrode Core Exposing Portion

What is claimed is:

1. A non-aqueous electrolyte secondary battery including an electrode assembly and a non-aqueous electrolyte, the electrode assembly having a positive electrode, a negative electrode and a separator separating the positive electrode and the negative electrode, the non-aqueous electrolyte secondary battery characterized in that the separator has a three-layer laminated structure, the melting point of the middle layer being lower than either of the two outer layers, and the non-aqueous electrolyte including lithium bis(oxalato)borate.

2. The non-aqueous electrolyte secondary battery according to claim 1, wherein the permeability per unit of thickness of the separator is from 7.0 to 27.0 seconds/mL·μm.

3. The non-aqueous electrolyte secondary battery according to claim 1, wherein the separator is uniaxially stretched, the positive electrode, the negative electrode and the separator in the electrode assembly are wound, and the winding direction is parallel to the stretching direction of the separator.

4. The non-aqueous electrolyte secondary battery according to claim 1, wherein the battery capacity of the non-aqueous electrolyte secondary battery is equal to or greater than 15 Ah.
